(19) United States
(12) Patent Application Publication
(10) Pub. No.: US 2008/0179881 A1
(43) Pub. Date: Jul. 31, 2008

(54) SEMI-RIGID, ADJUSTABLE DUCT CONNECTOR

(75) Inventors: Tom Crocket, Ridgeway (CA); John Falk, St. Catherines (CA)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: DEFLECTO CORPORATION, Indianapolis, IN (US)

(21) Appl. No.: 11/668,365

(22) Filed: Jan. 29, 2007

(51) Int. Cl. F16L 27/10

(52) U.S. Cl. 285/235

(57) ABSTRACT

A flexible, semi-rigid connector is provided. The connector comprises a sleeve with two openings on opposing ends and is made up of a plurality of ridges having interlocking crimped elements spaced. The crimped elements allow for the sleeve to be twisted and moved laterally to create a variety of lengths and angles in order to correctly connect the dryer vent and the exhaust vent.

### FIELD OF THE INVENTION

The present invention relates generally to air distributions products, and more specifically to a flexible, compact connector used, for example, to connect a clothes dryer vent with an exhaust vent.

### BACKGROUND OF THE INVENTION

Clothes dryers and other similar appliances force heated air out and away from the dryer or appliance. Homes and commercial laundry facilities have an exhaust vent to the outside or to other duct work within the building in order to get the hot air away from the dryer or appliance. Often the dryer vent and the exhaust vent are not in alignment, or the dryer vent is spaced apart from the exhaust vent. Therefore, in order to connect the dryer vent and the exhaust vent it is common to use a connector of some sort. Typically, the connector is coupled to the dryer vent and to the exhaust vent for proper ventilation of the hot air. Connectors are typically made of metal, plastic, or fabric, or a combination thereof, and have a variety of designs.

Several drawbacks or limitations exist with prior designs. Plastic and fabric materials often tear or become deformed to a degree that makes the dryer inefficient. Such materials are often too flexible and prone to fatigue from exposure to heat or from being moved or damaged by the components being connected. Moreover, while these material can be adjustable, they are poor in maintaining their shape after adjustment which leads to substantial difficulty in operation and maintenance. Metals can be too rigid to make the correct connection and alignment possible, and are difficult to maneuver and adjust. It would be beneficial to provide a connector that maintains its shape but is still flexible.

Proper connection between the dryer vent and the exhaust vent is important for proper ventilation and efficiency of the dryer. Connecting the dryer vent and the exhaust vent can be difficult because of the available space to work in to make this connection. Often the dryer is between the washer and the wall and is in a small closet or other restricted area. Due to space constraints it would be beneficial to provide a connector that was able to have a variety of angles and lengths.

### SUMMARY OF THE INVENTION

The present invention comprises a compact, semi-rigid, adjustable connector. A principal object of the present invention is to provide a multi-angle connector to connect a dryer vent and an exhaust vent that maintains the basic tubular shape while allowing for a variety of angles in order to make a proper connection between the dryer vent and the exhaust vent. The multi-angle connector is flexible 360 degrees to make an elbow type connection behind the dryer. The multi-angle connector comprises a tubular sleeve with an opening at each end of the sleeve. The sleeve has numerous ridges in order for the sleeve to bend in a variety of angles. Interlocking crimped lips are spaced apart (e.g., approximately every 10 ridges) to assist in achieving the desired adjustability of the connector. The connector provides for the proper alignment of the dryer vent and the exhaust vent and can be twisted and angled in order to fit any space and vent positioning. Also, the connector is made of a durable, semi-rigid flexible material in order to maintain the tubular shape of the sleeve.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention and various features thereof.

### BRIEF DESCRIPTION OF THE DRAWINGS

A preferred embodiment of the invention, illustrative of the best mode in which the applicant has contemplated applying the principles, is set forth in the following description and is shown in the drawings and is particularly and distinctly pointed out and set forth in the appended claims. The drawings submitted are informal and will be replaced with more formal drawings in the future.

FIG. 1 is a front view of a connector illustrating an exemplary embodiment of the present invention and showing the connector in a collapsed position.

FIG. 2 is a front view of the connector of FIG. 1 showing the connector in a partially extended and twisted configuration.

FIG. 3 is a front view of the connector of FIG. 1 showing the connector in a partially extended and curved configuration.

FIG. 4 is an enlarged partial sectional view of a wall of the connector of FIG. 1 showing interlocked elements prior to crimping.

FIG. 5 is an enlarged partial sectional view of a wall of the connector of FIG. 1 showing interlocked elements after crimping.

### DETAILED DESCRIPTION OF THE PREFERRED EMBODIMENT

As required, a detailed embodiment of the present inventions is disclosed herein; however, it is to be understood that the disclosed embodiment is merely exemplary of the principles of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

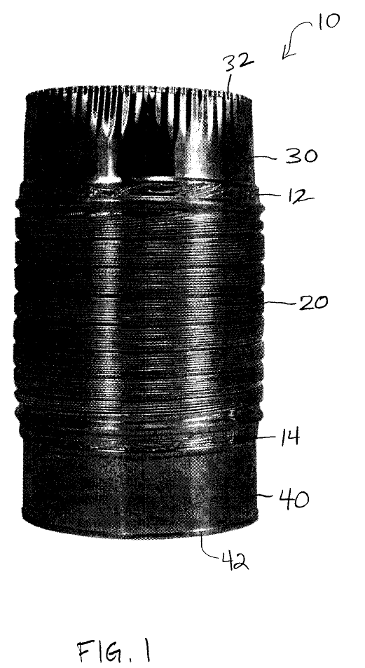

Referring to FIG. 1, the present invention comprises a flexible, semi-rigid connector 10 having a sleeve 20 which is generally tubular in shape mounted between first and second end caps 30, 40. In a preferred embodiment the connector 10 is fabricated from low-strength aluminum or other ductile, semi-rigid materials.

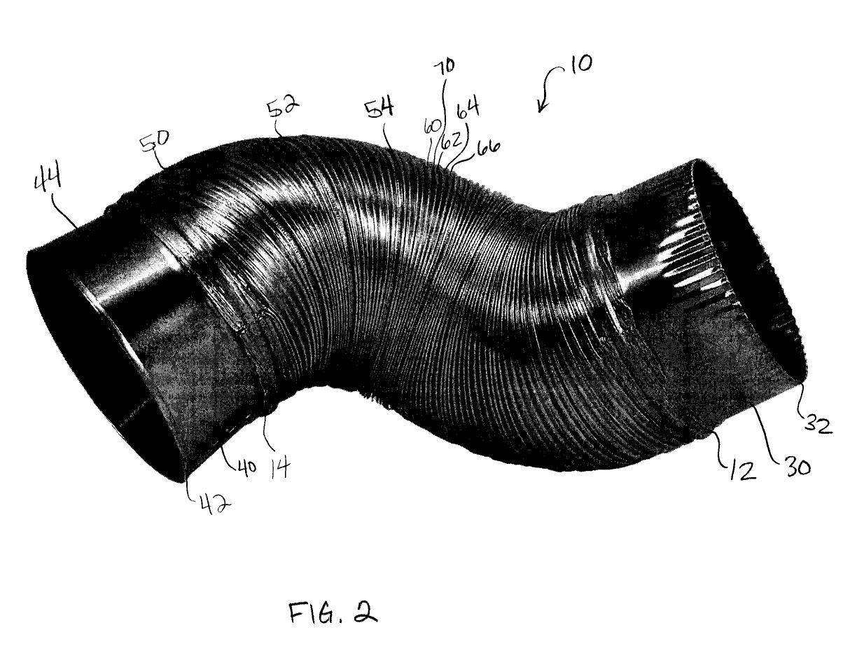

Referring to FIG. 2, the end caps 30, 40 are substantially similar. End cap 30 has a body portion 44 with uniform end 42 and a non-uniform end 32. The non-uniform end 32 presents a slightly smaller diameter to facilitate connection to other duct work (not shown).

End cap 40 is coupled to sleeve 20 at a non-uniform end 14, by rivets for example, with a uniform end 42 exposed. End cap 30 is similarly coupled to sleeve 20 at an uniform end 12, by rivets for example, with non-uniform end 32 exposed.

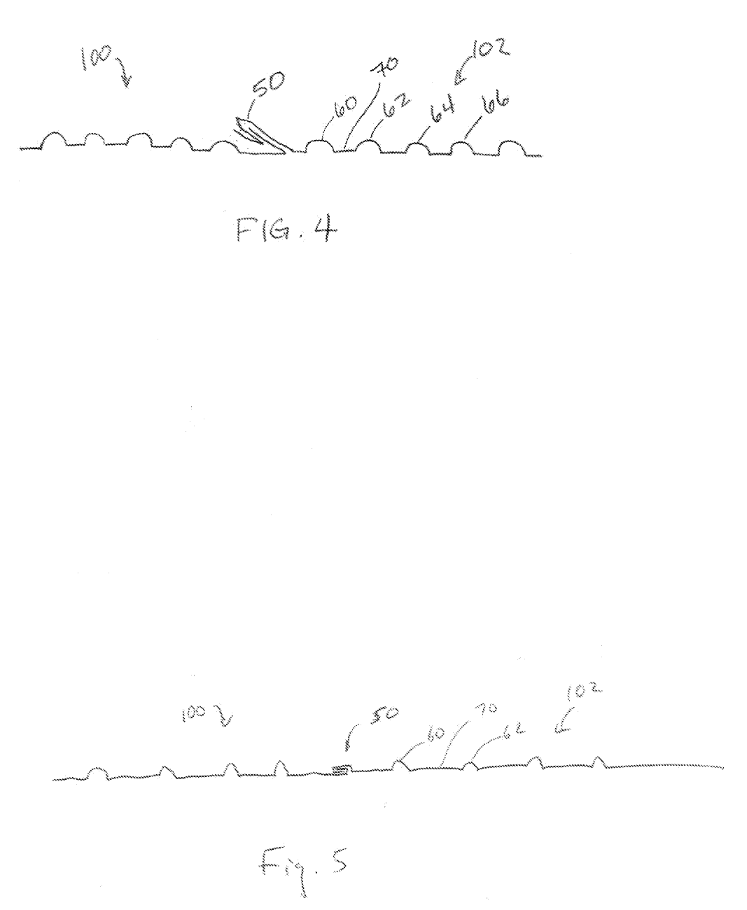

Referring to FIGS. 2 and 4, sleeve 20 has a plurality of ridges (e.g., 60, 62, 64, 66) spaced apart from each other to allow lateral and radial movement (e.g., extension and contraction and angular twisting) in virtually any direction. The ridges collapse upon one another when compressed together, and create a trough 70 between the ridges when extended.

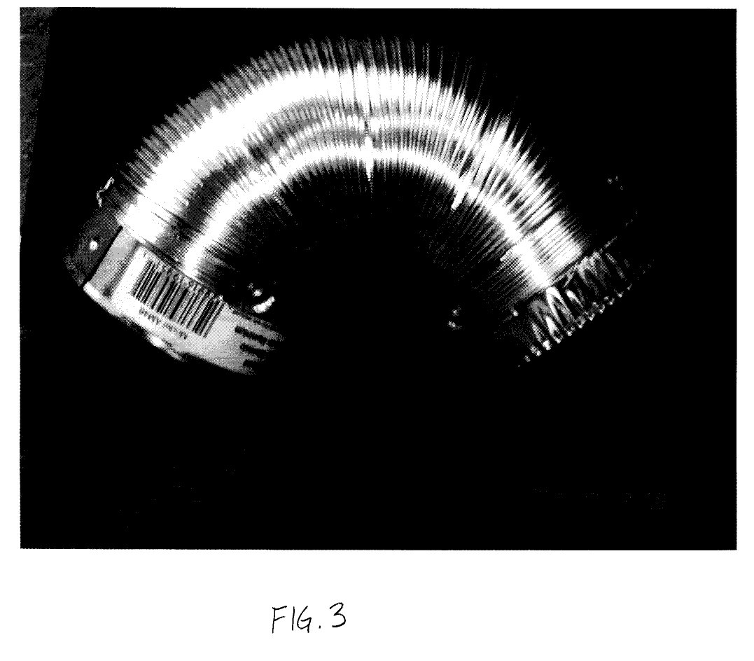

Referring to FIG. 3 and FIG. 4, sleeve 20 comprises a series of interconnected members 100, 102 which are joined together at lip 50. For example, in a preferred embodiment, at approximately every 10 ridges, the members 100, 102 are joined together by folding and crimping at the lip 50. By crimping the lip 50 becomes a fixed point such that at the lip 50 the member 100, 102 move together when the sleeve is moved laterally or angularly (i.e., twisted). FIG. 4 shows the configuration of the members 100, 102 prior to crimping, FIG. 5 shows the configuration of the members 100, 102 after crimping.

In operation the sleeve 20 can extended and/or compressed and/or rotated (e.g., curved or twisted) such that a variety of angles and lengths and shaped can be easily obtained. The flexible ridges 60, 62, 64, 66 allow for lateral and angular movement as depicted in FIGS. 1-3, and lip 50 provides strength to allow movement and maintain structural integrity of the sleeve in virtually any position. The sleeve can be rotated 360 degrees in multiple positions along the length of the sleeve 20 to allow maximum flexibility in connecting the sleeve to various components. The sleeve 20 is therefore easily adjustable by hand for example, and maintains its shape in the selected configuration after adjustment.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Although the foregoing detailed description of the present invention has been described by reference to an exemplary embodiment, and the best mode contemplated for carrying out the present invention has been shown and described, it will be understood that certain changes, modification or variations may be made in embodying the above invention, and in the construction thereof, other than those specifically set forth herein, may be achieved by those skilled in the art without departing from the spirit and scope of the invention, and that such changes, modification or variations are to be considered as being within the overall scope of the present invention. Therefore, it is contemplated to cover the present invention and any and all changes, modifications, variations, or equivalents that fall with in the true spirit and scope of the underlying principles disclosed and claimed herein. Consequently, the scope of the present invention is intended to be limited only by the attached claims, all matter contained in the above description and shown in the accompanying drawings shall be interpreted as illustrative and not in a limiting sense.

Having now described the features, discoveries and principles of the invention, the manner in which the invention is constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall therebetween.

What is claimed is:

1. A connector with openings at opposed ends of the connector, the connector comprising:
at least two body members, each body member having a plurality of ridges formed along the length thereof;
the body member joined together at a lip; and
wherein the sleeve is adjustable both laterally and angularly about the lip.

2. An air distribution system, comprising:
a sleeve with openings formed at opposite ends of the sleeve;
first and second end caps attached to the ends; and
a plurality of interlocking members affixed between the end caps, the members moveable in lateral and angular directions such that the configuration of the sleeve can be adjusted and the shape of the sleeve maintained after said adjustment.

3. An interlocking connection for a connector, comprising:
first and second members;
a plurality of ridges formed in each of the members to allow lateral and angular movement between the members;
the first and second members joined together by a crimped lip, the crimped lip providing a fixed position to provide strength and rigidity to the sleeve to allow the sleeve to be adjusted and maintain its shape after said adjustment.
